(19) United States
(12) Patent Application Publication
(10) Pub. No.: US 2006/0185495 A1
(43) Pub. Date: Aug. 24, 2006

(54) Supporting stand for a keyboard of a musical instrument

(76) Inventor: Wu-Hong Hsieh, Lu Chou City (TW)

Correspondence Address: DELLETT & WALTERS, P. O. BOX 82788, PORTLAND, OR, 97282-0788, US

(21) Appl. No.: 11/066,932

(22) Filed: Feb. 23, 2005

(51) Int. Cl. G10G 5/00; G10D 3/00

(52) U.S. Cl. 84/327

(57) ABSTRACT

A supporting stand for a keyboard of a musical instrument has two supporting members, two legs provided in each of the supporting members, and two shanks mounted internally in the supporting members. Multiple channels are defined in the supporting members and a positioning member engaged with the channels are provided on the shanks so that the shanks and the legs can independently be adjusted within a proper angle and be fastened via the positioning member engaged with the channel. Furthermore, the shanks can be folded towards the legs thereby decreasing the volume of the present invention for storage.

### BACKGROUND OF THE INVENTION

1. Field of the Invention

The present invention relates to a support stand for a keyboard of a musical instrument, and more particularly to a support stand which can steadily support a keyboard of a musical instrument.

2. Description of Related Art

Generally, a keyboard of a musical instrument such as an electric piano or synthesizer is retained at one of a variety of heights by a conventional supporting stand when a performer is playing the musical instrument. Hence, the height of the musical instrument can be adjusted to a proper location for the performer and the musical instrument can be steadily supported.

With reference to FIGS. 8-9, the conventional supporting stand for the keyboard of the musical instrument comprises a disk (70) and a first rod (73) and a second rod (73a) respectively mounted on two opposed sides of the disk (70). The disk (70) has a hole (not numbered) defined in a center thereof and multiple evenly-spaced openings (72) respectively defined along a periphery thereof. The disk (70) is mounted in a middle portion of the first and second rod (73, 73 a), and a shank (74), which is provided on the first rod (73), is perpendicular to the first rod (73) and relative to the openings (72). A shaft (740), which has a narrower cross section than that of the shank (74), is formed in a middle portion of the shank (74). The shank (74) is inserted into the first rod (73) and a coil spring (75) is mounted around the shaft (740) and in an interior of the first rod (73) so that the shank (74) can push the first rod (73) by a user's hand to rotate along the disk (70). When the first rod (73) is inclined to the second rod (73a) within a proper angle, the shank (74) can be inserted into the respective opening (72) thereby fastening the first and second rod (73, 73a).

When the user wants to adjust the conventional supporting stand for the musical instrument, the user must pull the shank (74) thereby compressing the coil spring (75) with one hand so that an end of the shank (74) can move out of the opening (72). Furthermore, the user should adjust the first rod (73) relative to the second rod (73a) in an angle by using the other hand and therefore, the user requires the other person's help to support the second rod (73a).

Additionally, a top angle between the first and second rod (73, 73a) is adjusted relative to a lower angle between them such that the conventional supporting stand for the keyboard of the music instrument can not achieve an effect that both of the top and the lower angle are small or both of them are big.

Furthermore, the first and second rod (73, 73a) can not be folded with the conventional supporting stand for the musical instrument and therefore, it is inconvenient to store the stand.

Therefore, the invention provides a support stand for a keyboard of a musical instrument to mitigate or obviate the aforementioned problems.

### SUMMARY OF THE INVENTION

The main objective of the present invention is to provide a supporting stand for a keyboard of a musical instrument with which it is easy to adjust an angle between shanks of the present invention and it is convenient to store the stand.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a support stand for a keyboard of a music instrument in accordance with the present invention;

FIG. 2 is an exploded perspective view of the support stand for the keyboard of the music instrument in accordance with the present invention;

FIG. 3 is a perspective partial view of the support stand for the keyboard of the musical instrument in accordance with the present invention in usage;

FIG. 4 is a sectional view of a shank in accordance with the present invention;

FIG. 5 is a sectional view of the shank in accordance with the present invention being adjusted;

FIG. 6 is a flat view of the supporting stand for the keyboard of the musical instrument in accordance with the present invention being adjusted;

FIG. 7 is a perspective view of the supporting stand for the keyboard of the musical instrument in accordance with the present invention with the keyboard placed thereon;

FIG. 8 is a perspective view of a conventional supporting stand for a keyboard of a musical instrument; and

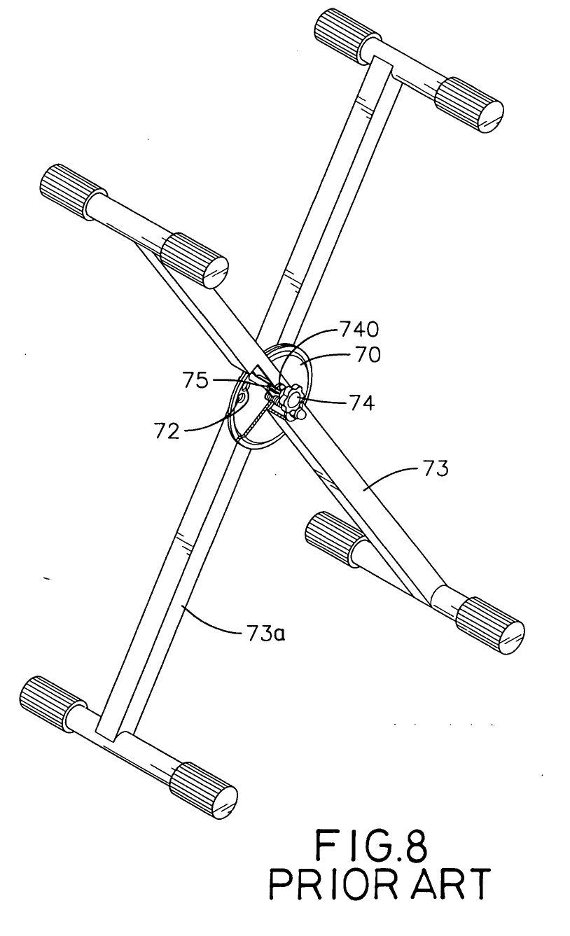

FIG. 9 is a partially sectional view of the conventional supporting stand for the keyboard of the musical instrument.

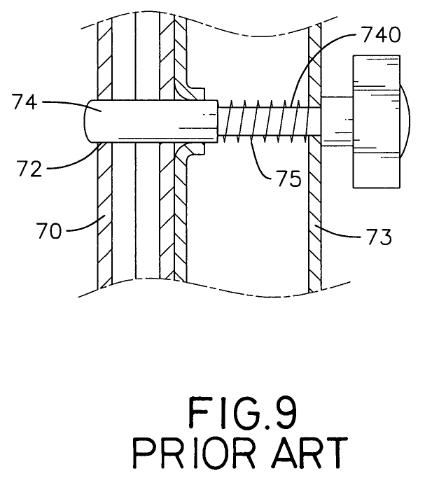

### DETAILED DESCRIPTION OF THE PREFERRED EMBODIMENT

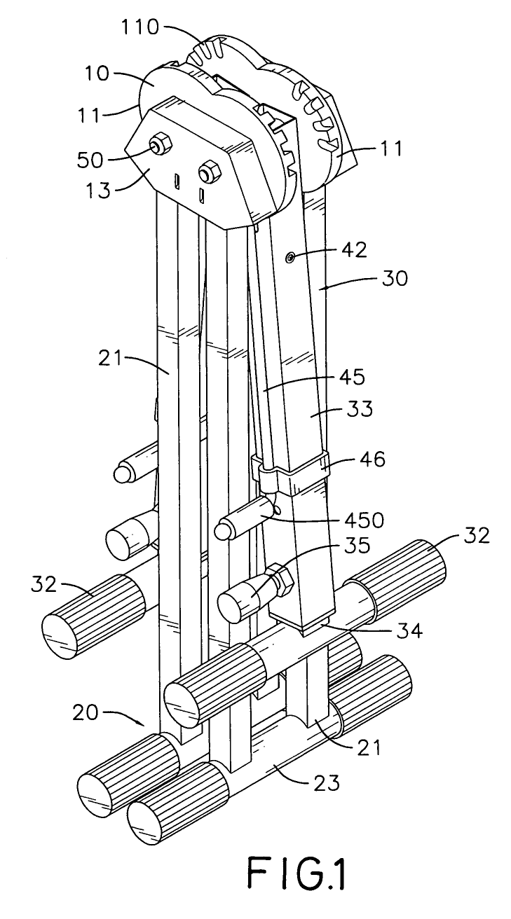

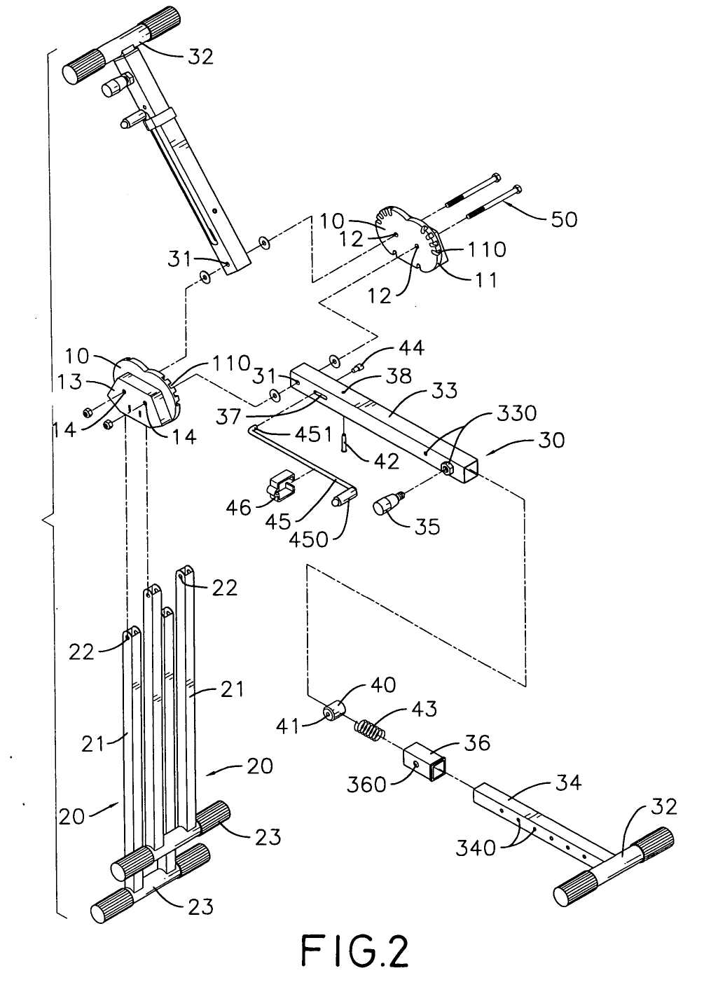

With reference to FIGS. 1-2, a supporting stand for a keyboard of a musical instrument comprises two supporting members (10), two legs (20), two shanks (30), a positioning member, and pivotal members (50).

Each supporting member (10) has two arcuate portions (11) formed on two sides thereof, multiple channels (110) defined in the periphery of the corresponding arcuate portions (11), and a first hole (12) respectively defined in a center of circle of each arcuate portion (11). Two caps (13), which are provided on an outer wall of the supporting members (10), respectively have two second holes (14) corresponding to the first holes (12) and an opening end in a lower end thereof.

Each leg (20), which can be inserted into the opening end of the caps (13), has two parallel shafts (21) provided on thereof, multiple symmetrical openings (22) defined in a top end of the shaft (21) and a first foot (23) provided on a lower end of and perpendicular to the shaft (21).

Each shank (30), a top end of which can be attached to the respective supporting member (10), has multiple first apertures (31) defined in a first end thereof, and a second foot (32) mounted on a second end thereof and perpendicular thereto. The positioning member, which can be engaged with the channels (110), is mounted on the shanks (30).

The pivotal members (50) are respectively inserted into the second holes (14), the openings (22), the first holes (12), and the first apertures (31) in turn so that the legs (20) can be pivotally mounted between the caps (13), and the shanks (30) can be provided between the supporting members (10). In a first preferred embodiment of the present invention, the pivotal members (50) are nuts and bolts.

Also in the first preferred embodiment of the present invention, each shank (30) comprises an inner tube (34) and an outer tube (33). Multiple symmetrical first apertures (31) are provided in a first side end of the outer tube (33) and multiple threaded holes (330) are defined in a second side end of the outer tube (33). The inner tube (34), a first end of which is inserted into the outer tube (33), has the second foot (32) mounted on a second end thereof and perpendicular thereto, and multiple evenly-spaced second apertures (340) defined in an axial periphery thereof. A screw rod (35) can be inserted into the threaded holes (330) and the second apertures (340). A hollow barrel (36) is mounted in an interior of the outer tube (33) to decrease the friction between the inner tube (34) and the outer tube (34). A through hole (360) corresponding to the threaded holes (330) is defined in the hollow barrel (36) so that the inner tube (34) is inserted into the hollow barrel (36) and fastened via the screw rod (35) being inserted into the second apertures (340) after the screw rod (35) is received into the threaded hole (330) and the through hole (360).

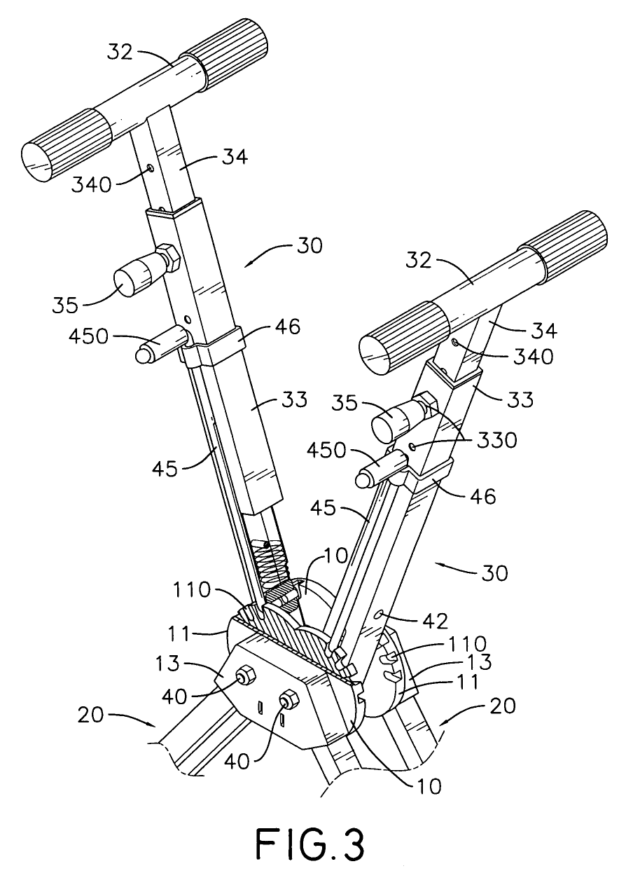

With reference to FIGS. 2-4, two symmetrical slots (37) are defined in the first side end of the outer tube (33) and behind the first apertures (31), and two symmetrical third apertures (38) are defined in a front first end of the outer tube (33). The positioning member has a pivotal block (40) which can be received into the slots (37) and has an orifice (41) defined in a center of the pivotal block (40), a first pin (42) inserted into the third apertures (38), a coil spring (43) fastened between the pivotal block (40) and the first pin (42), a second pin (44) received into a first end of the orifice (41), a bar (45) provided on a second end of the orifice (41), and a clip (46) provided on an exterior of the outer tube (33) thereby fastening the bar (45). The bar (45) has a finger (450) integrally formed on a first end thereof and a lug (451) integrally formed on a second end thereof and inserted into the orifice (41).

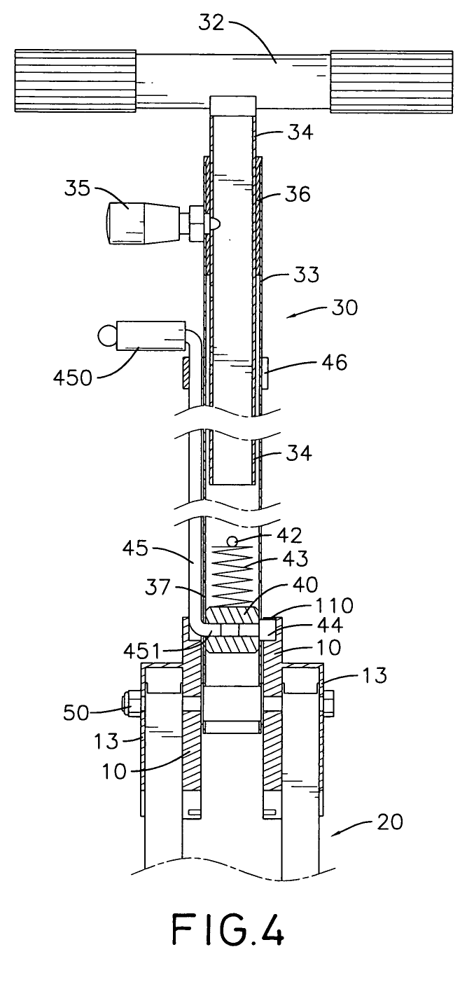

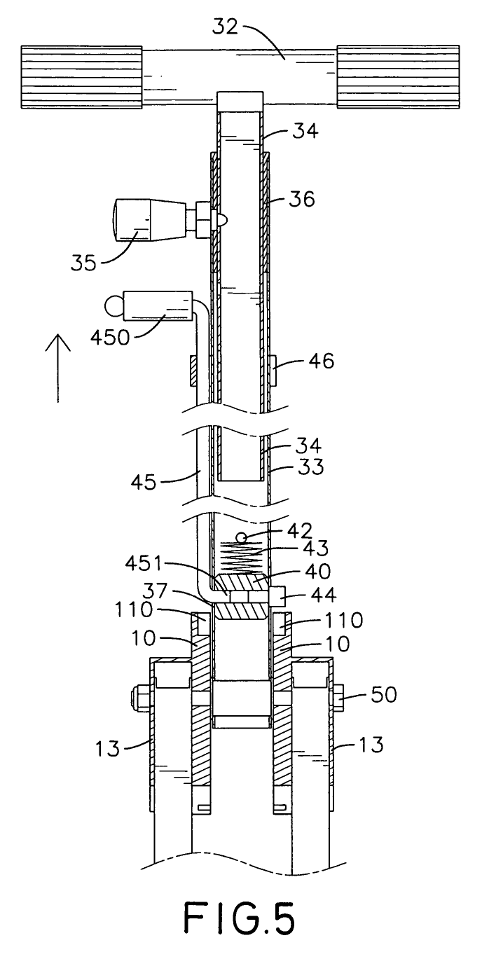

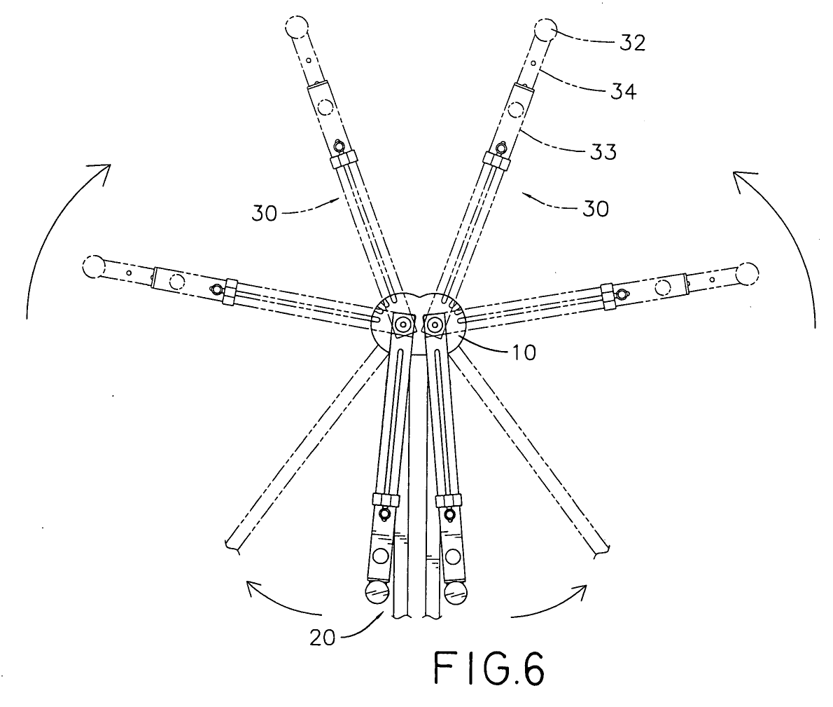

With reference to FIG. 4, when the shank (30) has been already adjusted, the second pin (44) is inserted in the channel (110) so that the shanks (30) can be fastened in a proper angle. With reference to FIGS. 5-6, when a user wants to adjust the height of the shanks (30), the bar (45) are pushed towards the screw rod (35) due to the finger (450) being handled by a single hand of the user so that the pivotal block (40) can be driven by the lug (451) to compress against the coil spring (43) thereby moving the pivotal block (40) towards the second foot (32). Meanwhile, the second pin (44) separates from the channel (110) so that the shanks (30) can be freely adjusted within a desired angle relative to each other and corresponding to the positioning member as a pivotal center. When the shanks (30) are adjusted to a proper angle, the finger (450) can be released by the user, the pivotal block (40) can move opposed to the second foot (32) via a resiliency of the coil spring (43) and the second pin (44) can be engaged with the channel (110) again.

Additionally, when the shanks (30) are adjacent to the legs (20), it is easy for the supporting stand for the keyboard of the musical instrument to be stored via decreasing the volume of the present invention.

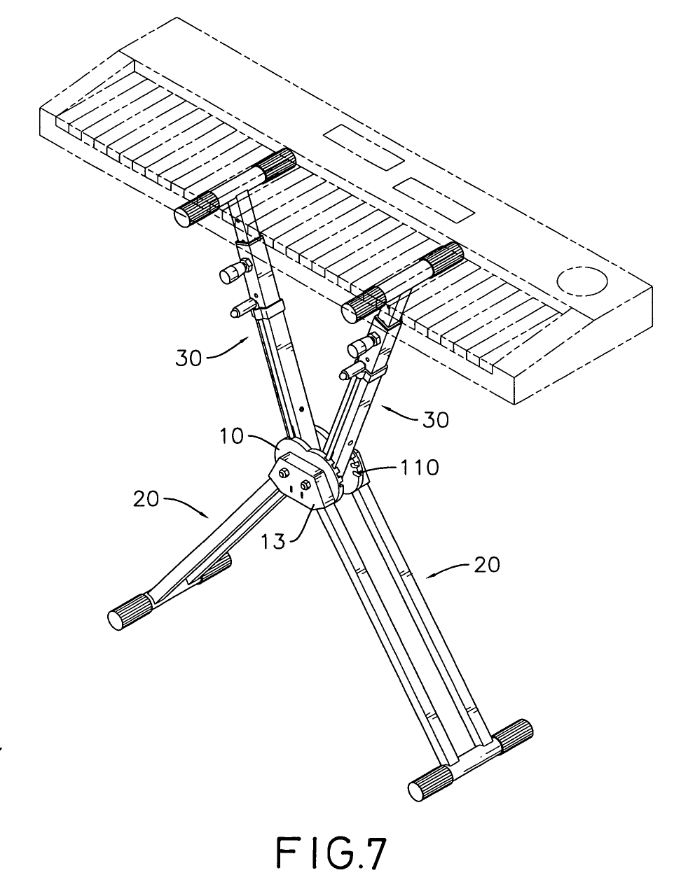

With reference to FIG. 7, the legs (20) can be pivotally rotated independently between the caps (13) and the shanks (30) can also be adjusted independently between the supporting members (10) so that an excellent effect of the usage can be achieved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A supporting stand for a keyboard of a musical instrument comprising:
two supporting members (10);
two legs (20);
two shanks (30);
a positioning member; and
at least one pivotal member (50),
wherein each supporting member (10) has:
two arcuate portions (11);
multiple channels (110) defined in a periphery of each arcuate portion (11);
two first parallel holes (12) defined in a center of each arcuate portion (11); and
two caps (13) mounted around the supporting members (10) and each cap (13) having an opening end in a lower end thereof and two second holes (14) corresponding to the first holes (12);
each leg (20) is inserted into a respective cap (13) and has two parallel shafts (21), multiple symmetrical openings (22) defined in a top end of each shaft (21) and a first foot (23) mounted on a lower end of the shafts (21);
each shank (30) is mounted between the supporting members (10) and has multiple first apertures (31) defined in a first end thereof, a second foot (32) mounted on a second end thereof;
the positioning member is provided on the shanks (30) and engaged with the channel (110); and
the at least one pivotal member (50) is inserted into the first holes (12), the second holes (14), the openings (22) and the first apertures (31), whereby the legs (20) can be pivotally mounted between the caps (13) and the shanks (30) can be pivotally mounted between the supporting members (10).

2. The supporting stand for the keyboard of the musical instrument as claimed in claim 1, wherein the at least one pivotal member (50) is a nut and bolt.

3. The supporting stand for the keyboard of the musical instrument as claimed in claim 1, wherein each shank (30) has an inner tube (34) and an outer tube (33), multiple first apertures (31) defined in a first end of the outer tube (33) and the inner tube (34) is inserted into a second end of the outer tube (33), multiple evenly-spaced second apertures (340) defined in an axial periphery of the inner tube (34), multiple threaded holes (330) defined in the second end of the outer tube (33), whereby a screw rod (35) is inserted into the threaded holes (330) and the second apertures (340).

4. The supporting stand for the keyboard of the musical instrument as claimed in claim 3, wherein a hollow barrel (36) which has two through holes (360) defined in a center thereof and corresponding to the threaded holes (330).

5. The supporting stand for the keyboard of the musical instrument as claimed in claim 3, wherein two slots (37) are defined adjacent to the first end of the outer tube (33) and a third aperture (38) is defined in a front first end of the outer tube (33), the positioning member has a pivotal block (40) which is received into the slots (37) and has an orifice (41) defined in a center of the pivotal block (40), a first pin (42) is inserted into the third apertures (38), a coil spring (43) is fastened between the pivotal block (40) and the first pin (42), a second pin (44) is received into a first end of the orifice (41), a bar (45) is provided on a second end of the orifice (41), and a clip (46) is provided on an exterior of the outer tube (33).

6. The supporting stand for the keyboard of the musical instrument as claimed in claim 5, wherein a finger (450) is integrally formed at a first end of a bar (45) and a lug (451) is integrally formed at a second end of the bar (45).
